(19) United States
(12) Patent Application Publication
(10) Pub. No.: US 2011/0003163 A1
(43) Pub. Date: Jan. 6, 2011

(54) Composite Materials

(75) Inventor: Alan Wood, Cumbria (GB)

Correspondence Address: DOWNS RACHLIN MARTIN PLLC, 199 MAIN STREET, P O BOX 190, BURLINGTON, VT, 05402-0190, US

(73) Assignee: VICTREX MANUFACTURING LIMITED, Lancashire (GB)

(21) Appl. No.: 12/919,978

(22) PCT Filed: Feb. 11, 2009
(86) PCT No.: PCT/GB09/50134

§ 371 Date: Aug. 27, 2010

(30) Foreign Application Priority Data
Feb. 29, 2008 (GB) 0803823.4

(51) Int. Cl. B32B 27/28; B32B 27/04; B32B 27/06; B32B 5/02; B32B 37/02

(52) U.S. Cl. 428/525; 428/411.1; 428/524; 156/60

(57) ABSTRACT

A polyetheretherketone film is used in the consolidation of a prepreg so that the film becomes incorporated into the consolidated prepreg, defines an outer layer of the consolidated prepreg and therefore provides the consolidated prepreg with advantageous properties. In one embodiment, a film may be used as a bagging material. In this embodiment, prepreg is positioned in a mould to define a precursor of a composite material. A bagging film is positioned next to the prepreg and a vacuum is applied via port to evacuate the space between the prepreg and film and induction heating is used to cause the resin in the prepreg to melt. In addition, the film yields and draws and this stretched film will cover the prepreg and act as a bagging material. Another embodiment addresses the problem of insertion and/or removal of an inflatable bladder in the manufacture of hollow articles and utilizes a gas filled thermoplastic bag.

This invention relates to composite materials and particularly, although not exclusively, relates to composite materials based on continuous or semi-continuous fibre reinforcement associated with a plastics matrix material which may comprise a thermoplastic or thermosetting resin. Preferred embodiments utilise a matrix material which comprises a polyaryletherketone polymer, for example polyetheretherketone.

The use of composites, for example comprising high performance polymers such as Victrex PEEK (a polyetheretherketone polymer obtained from Victrex Plc, UK), in the aerospace industry is seen as one major route to reducing the weight of aircraft, improving efficiency and thereby reducing environmental impact of the industry.

One of the keys to the increased use of composites is through improved manufacturing techniques which aim to reduce the cost of manufacture, cost of tooling, enable complex components to be manufactured more easily and facilitate rapid expansion of manufacturing volume with limited capital investment.

Typically, processing of composite materials involves a first stage in which fibre reinforcement is mixed with a matrix material to form a prepreg or a fabric is impregnated with matrix material to form a prepreg. In a second stage, one or more layers of prepreg is/are consolidated, normally by application of heat and pressure to define the composite material.

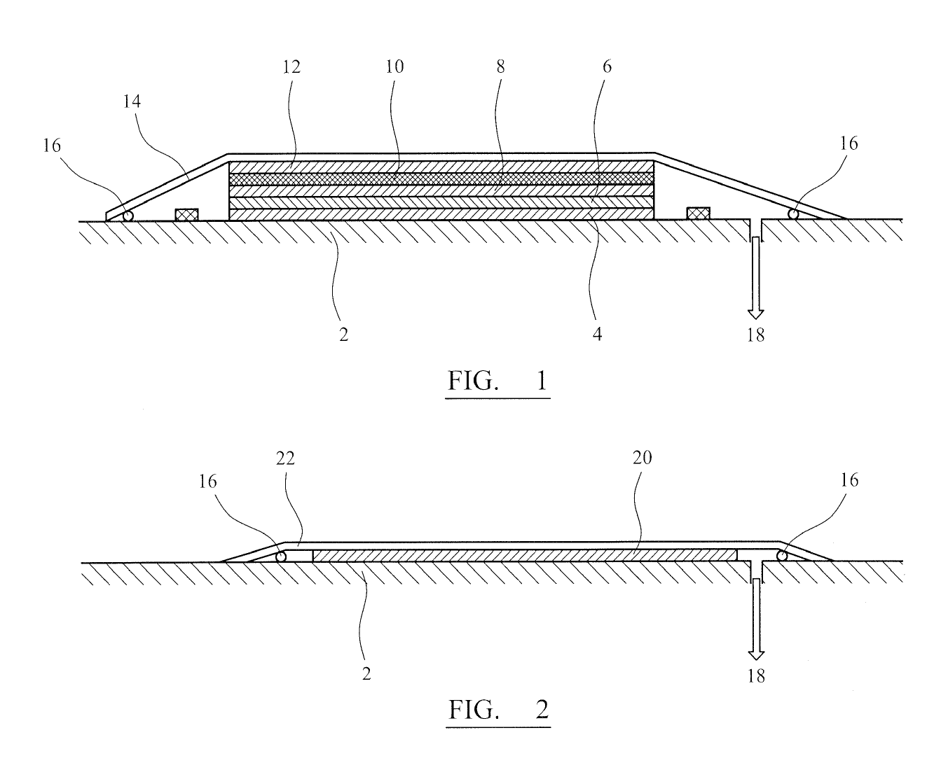

One method of consolidation uses a bag system to apply pressure to a prepreg as illustrated in FIG. 1 of the accompanying drawings which is a cross-section of a mould tool having a prepreg laid-up therein. Referring to the figure, there is shown a mould 2 on which a precursor of a composite material 4 which includes one or a multiplicity of layers of prepreg is arranged. A bleeder layer 6 is arranged over the precursor 4 and a release ply 8 is arranged over the layer 6. A pressure plate 10 contacts the bleeder layer 6 and a breather layer 12 is arranged over the pressure plate 10. A bagging film or sheet 14 is arranged over the breather layer 12 to define a vacuum bag which is sealed to the mould 2 by seals 16, for example using silicone sealants so that a sealed space is defined between the vacuum bag and prepreg.

At the start of the moulding process, air is withdrawn from the sealed space via a vacuum port 18 thus applying a uniform pressure of about one bar to the prepreg within. The tool is heated, for example by being placed in an oven or autoclave, to the moulding temperature of matrix material contained in the layers of prepreg and consequently the prepreg is consolidated over time by application of the heat and the pressure applied via the vacuum bag.

After consolidation, the mould is allowed to cool and subsequently the bag and then the consolidated composite material 4 are removed from the mould. In some cases the bag can be re-used; or in other cases discarded.

Typically, bags are made from silicone rubber. When the prepreg comprises a thermosetting resin such bags can often be re-used in view of the relatively low temperatures involved in the consolidation process. However, if a silicone rubber bag was used in the consolidation of prepregs comprising high performance thermoplastics such as Victrex PEEK, when processing temperatures of the order of 400° C. may be used, the lifetime of the bag would be relatively short and could be restricted to a single use. This may make the bagging technique described economically unacceptable for many applications.

One current development is the fabrication of composite structures produced using a knitting process. In order to improve mechanical properties and reduce materials costs, it is often beneficial to manufacture hollow articles. For example, composite tubes may be made using a knitted resin impregnated prepreg. A bladder is inflated down the centre of a composite lay-up to push the lay-up out against a cylindrical surface to define the shape of the composite tube. Disadvantageously, an access hole must be provided for insertion and removal of the bladder. Where there are no access routes, fabrication must be completed in at least two sections which are subsequently jointed together. The joint however represents a potential weak point in the structure.

It is an object of the present invention to address at least some of the aforementioned problems.

According to a first aspect of the invention, there is provided a method of consolidating a prepreg, the method comprising:

(i) positioning a film adjacent a prepreg to be consolidated; and

(ii) applying a force for consolidating the prepreg, wherein the film becomes attached to the prepreg.

As a result, a consolidated prepreg may be made which includes an outer (or inner) surface defined at least in part by material of said film. The method may therefore provide a means whereby an outer (or inner) surface of a composite material made by consolidating one or more layers of prepreg may be made more smooth and/or aerodynamic; have improved damage resistance; and/or have improved chemical resistance, amongst other advantages described hereinafter.

The method suitably involves selecting a film and prepreg which are compatible such that the film is able to become attached (and remain attached) to the prepreg in the method. More particularly, the film and prepreg are preferably such that the film is able to become attached to the prepreg when the film and/or prepreg are heated and/or a force is applied to urge the film and prepreg together.

The strength with which the film is attached to the prepreg may be defined by its peel strength for example based on a 90° peel using ASTM D3330. The peel strength, suitably measured as aforesaid, of the film from the consolidated prepreg may be at least 1 N/cm, preferably at least 1.5 N/cm, more preferably at least 2 N/cm, especially at least 2.5 N/cm.

The film may comprise one or more layers. For example, one layer may be arranged to become attached to the prepreg and another layer may be arranged to define part of a surface of the consolidated prepreg. When a film includes a plurality of layers, layers of said film may initially when selected for use in the method be separate from one another and/or not attached to one another; or, alternatively, a film may be selected which includes a plurality of layers fixed relative to one another. Such a film may comprise a laminate or co-extruded film. When a film includes a plurality of layers, one surface of the film could be different (e.g. chemically) from an opposite surface of the film. One surface could therefore provide a surface of a composite material prepared in the method with desired surface properties, whereas the other surface of the film could provide a means of bonding the film to prepreg. The film may comprise a polypropylene co-extruded film. Alternatively, the film may comprise a layer of polyetherketone and a layer of polyetherimide. In a further embodiment, the film may include a tie layer between outer layers of the film, wherein the tie layer is arranged to facilitate securing of the layers together. Preferably, however, the film does not include more than one layer.

The film may have a thickness in the range 5 μm to 750 μm. The thickness may be less than 500 μm, preferably less than 250 μm, more preferably less than 100 μm, especially less than 50 μm. The thickness may be at least 10 μm. Suitably the thickness is in the range 10 to 50 μm.

The puncture resistance of the film may be at least 10 kJ/m², preferably at least 20 kJ/m², when tested according to Def Stan 81-75.

The film may include additives to adjust its properties. For example, it may incorporate conductive materials such as carbon black, to modify electrical properties of the film. Preferably, however, the film includes less than 5 wt %, less than 2 wt %, less than 1 wt % of additives. Preferably, the film does not include any additives but consists essentially of resin.

Whilst the film could include a mixture of resins, it suitably includes at least 95 wt %, preferably at least 97 wt %, more preferably at least 99 wt % of a single resin. Preferably, the film consists essentially of a single resin. Said film preferably comprises (and more preferably consists essentially of) a thermoplastic resin.

Said film may comprise a material selected from a first polymer as herein described, a polyaryletherketone, a polyarylethersulphone, a polyphenylene sulphide, a polyetherimide, a polyamide and a polyolefin.

Preferred polyaryletherketones are as described herein for said first polymer.

Preferred polyarylethersulphones include polyethersulphone, polyetherethersulphone, polysulphone, Polyphenylenesulphone, poly-ether-diphenyl-ether-phenyl-sulphone-phenyl-, poly-ether-diphenyl-ether-phenyl-sulphone-diphenyl-sulphone-phenyl-, poly-ether-phenyl-sulphone-phenyl-ether-phenyl-sulphone-diphenyl-sulphone-phenyl-, and Poly-ether-phenyl-ether-phenyl-sulphone-diphenyl-sulphone-phenyl-.

Preferred polyetherimides include aromatic polyetherimides which may comprise a repeat unit of formula.

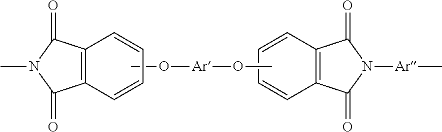

where Ar′ and Ar″ are independently selected from an aromatic group containing radical, as described in U.S. Pat. No. 5,110,880, the contents of which are incorporated herein by reference. A preferred polyetherimide includes a repeat unit of formula

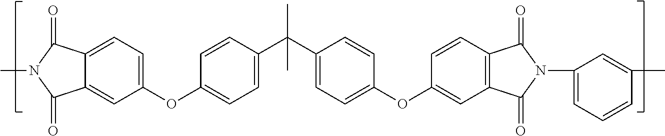

Preferred polyamides include polyamide 6, 66, 12 or 46. The polyamide may be DSM PA4T (Trade Mark).

Preferred polyolefins include polyethylene and polypropylene.

Preferably, the melting point of the film is higher than or equal to the melting point of resin in the prepreg in a region of the prepreg to which the film becomes attached in the method. Thus, in the method, the film suitably does not melt prior to melting of resin in the prepreg. Thus, the method preferably comprises selecting a film having a melting point which is higher than or equal to the melting point of a resin in the prepreg.

The film may comprise (preferably consist essentially of) a first polymer.

Said first polymer may have a Tg of less than 260° C., for example less than 220° C. or less than 200° C. In some cases, the Tg may be less than 190° C., 180° C. or 170° C.

Said first polymer suitably has a melt viscosity (MV) of at least 0.06 kNsm⁻², preferably has a MV of at least 0.08 kNsm⁻², more preferably at least 0.085 kNsm⁻², especially at least 0.09 kNsm⁻².

MV is suitably measured using capillary rheometry operating at 400° C. at a shear rate of 1000 s⁻¹ using a tungsten carbide die, 0.5×3.175 mm.

Said first polymer may have a MV of less than 1.00 kNsm⁻², suitably less than 0.5 kNsm⁻², preferably less than 0.38 kNsm⁻², more preferably less than 0.25 kNsm⁻², especially less than 0.12 kNsm⁻².

Said first polymer may have a tensile strength, measured in accordance with ASTM D790 of at least 40 MPa, preferably at least 60 MPa, more preferably at least 80 MPa. The tensile strength is preferably in the range 80-110 MPa, more preferably in the range 80-100 MPa.

Said first polymer may have a flexural strength, measured in accordance with ASTM D790 of at least 145 MPa. The flexural strength is preferably in the range 145-180 MPa, more preferably in the range 145-165 MPa.

Said first polymer may have a flexural modulus, measured in accordance with ASTM D790, of at least 2 GPa, preferably at least 3 GPa, more preferably at least 3.5 GPa. The flexural modulus is preferably in the range 3.5-4.5 GPa, more preferably in the range 3.5-4.1 GPa.

Said first polymer may have a tensile strength, measured in accordance with ASTM D790 of at least 20 MPa, preferably at least 60 MPa, more preferably at least 80 MPa. The tensile strength is preferably in the range 80-110 MPa, more preferably in the range 80-100 MPa.

Said first polymer may have a flexural strength, measured in accordance with ASTM D790 of at least 50 MPa, preferably at least 100 MPa, more preferably at least 145 MPa. The flexural strength is preferably in the range 145-180 MPa, more preferably in the range 145-164 MPa.

Said first polymer may have a flexural modulus, measured in accordance with ASTM D790, of at least 1 GPa, suitably at least 2 GPa, preferably at least 3 GPa, more preferably at least 3.5 GPa. The flexural modulus is preferably in the range 3.5-4.5 GPa, more preferably in the range 3.5-4.1 GPa.

Preferably, said first polymer has a moiety of formula

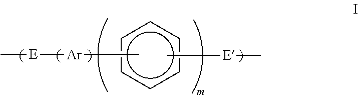

and/or a moiety of formula

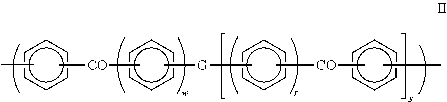

and/or a moiety of formula

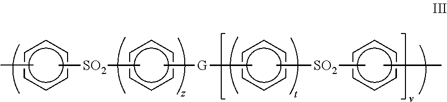

wherein m,r,s,t,v,w and z independently represent zero or a positive integer, E and E′ independently represent an oxygen or a sulphur atom or a direct link, G represents an oxygen or sulphur atom, a direct link or a —O-Ph-O— moiety where Ph represents a phenyl group and Ar is selected from one of the following moieties (i)**, (i) to (iv) which is bonded via one or more of its phenyl moieties to adjacent moieties

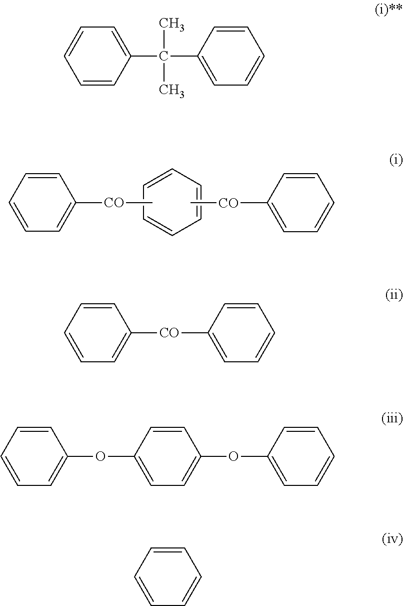

Unless otherwise stated in this specification, a phenyl moiety has 1,4-, linkages to moieties to which it is bonded.

In (i), the middle phenyl may be 1,4- or 1,3-substituted. It is preferably 1,4-substituted.

Said first polymer may include more than one different type of repeat unit of formula I; and more than one different type of repeat unit of formula II; and more than one different type of repeat unit of formula III. Preferably, however, only one type of repeat unit of formula I, II and/or III is provided.

Said moieties I, II and III are suitably repeat units. In the first polymer, units I, II and/or III are suitably bonded to one another—that is, with no other atoms or groups being bonded between units I, II and III.

Phenyl moieties in units I, II and III are preferably not substituted. Said phenyl moieties are preferably not cross-linked.

Where w and/or z is/are greater than zero, the respective phenylene moieties may independently have 1,4- or 1,3-linkages to the other moieties in the repeat units of formulae II and/or III. Preferably, said phenylene moieties have 1,4-linkages.

Preferably, the polymeric chain of the first polymer does not include a —S— moiety. Preferably, G represents a direct link.

Suitably, “a” represents the mole % of units of formula I in said first polymer, suitably wherein each unit I is the same; “b” represents the mole % of units of formula II in said first polymer, suitably wherein each unit II is the same; and “c” represents the mole % of units of formula III in said first polymer, suitably wherein each unit III is the same. Preferably, a is in the range 45-100, more preferably in the range 45-55, especially in the range 48-52. Preferably, the sum of b and c is in the range 0-55, more preferably in the range 45-55, especially in the range 48-52. Preferably, the ratio of a to the sum of b and c is in the range 0.9 to 1.1 and, more preferably, is about 1. Suitably, the sum of a, b and c is at least 90, preferably at least 95, more preferably at least 99, especially about 100. Preferably, said first polymer consists essentially of moieties I, II and/or III.

Said first polymer may be a homopolymer having a repeat unit of general formula

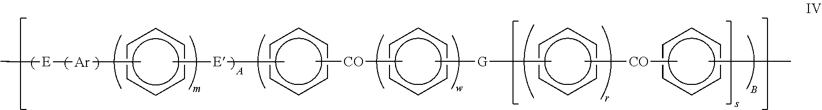

or a homopolymer having a repeat unit of general formula

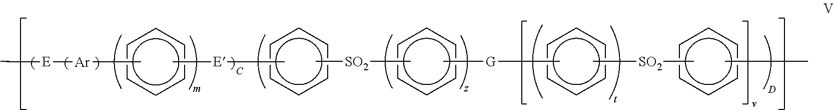

or a random or block copolymer of at least two different units of IV and/or V
wherein A, B, C and D independently represent 0 or 1 and E,E′,G,Ar,m,r,s,t,v,w and z are as described in any statement herein.

Preferably, m is in the range 0-3, more preferably 0-2, especially 0-1. Preferably, r is in the range 0-3, more preferably 0-2, especially 0-1. Preferably t is in the range 0-3, more preferably 0-2, especially 0-1. Preferably, s is 0 or 1. Preferably v is 0 or 1. Preferably, w is 0 or 1. Preferably z is 0 or 1.

Preferably, said first polymer is a homopolymer having a repeat unit of general formula IV.

Preferably Ar is selected from the following moieties (xi)** and (vii) to (x)

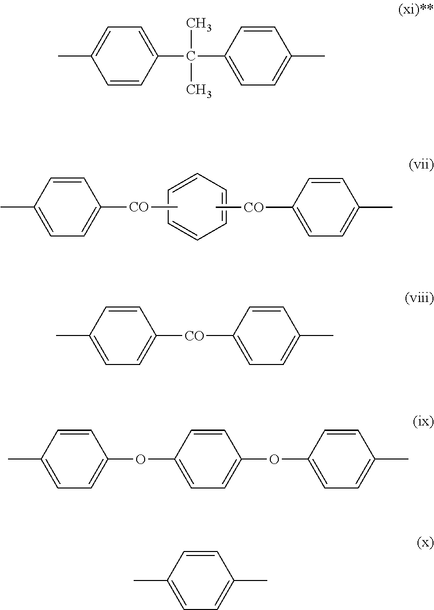

In (vii), the middle phenyl may be 1,4- or 1,3-substituted. It is preferably 1,4-substituted.

Suitable moieties Ar are moieties (i), (ii), (iii) and (iv) and, of these, moieties (i), (ii) and (iv) are preferred. Other preferred moieties Ar are moieties (vii), (viii), (ix) and (x) and, of these, moieties (vii), (viii) and (x) are especially preferred.

An especially preferred class of first polymers are polymers (or copolymers) which consist essentially of phenyl moieties in conjunction with ketone and/or ether moieties. That is, in the preferred class, the first polymer material does not include repeat units which include —S—, —SO₂— or aromatic groups other than phenyl. Preferred first polymers of the type described include:
(a) a polymer consisting essentially of units of formula IV wherein Ar represents moiety (iv), E and E′ represent oxygen atoms, m represents 0, w represents 1, G represents a direct link, s represents 0, and A and B represent 1 (i.e. polyetheretherketone).
(b) a polymer consisting essentially of units of formula IV wherein E represents an oxygen atom, E′ represents a direct link, Ar represents a moiety of structure (i), m represents 0, A represents 1, B represents 0 (i.e. polyetherketone);
(c) a polymer consisting essentially of units of formula IV wherein E represents an oxygen atom, Ar represents moiety (i), m represents 0, E′ represents a direct link, A represents 1, B represents 0, (i.e. polyetherketoneketone).
(d) a polymer consisting essentially of units of formula IV wherein Ar represents moiety (i), E and E′ represent oxygen atoms, G represents a direct link, m represents 0, w represents 1, r represents 0, s represents 1 and A and B represent 1. (i.e. polyetherketoneetherketoneketone).
(e) a polymer consisting essentially of units of formula IV, wherein Ar represents moiety (iv), E and E′ represents oxygen atoms, G represents a direct link, m represents 0, w represents 0, s, r, A and B represent 1 (i.e. polyetheretherketoneketone).
(f) a polymer comprising units of formula IV, wherein Ar represents moiety (iv), E and E′ represent oxygen atoms, m represents 1, w represents 1, A represents 1, B represents 1, r and s represent 0 and G represents a direct link (i.e. polyether-diphenyl-ether-phenyl-ketone-phenyl-).

Said first polymer may be amorphous or semi-crystalline. Said first polymer is preferably semi-crystalline. The level and extent of crystallinity in a polymer is preferably measured by wide angle X-ray diffraction (also referred to as Wide Angle X-ray Scattering or WAXS), for example as described by Blundell and Osborn (Polymer 24, 953, 1983). Alternatively, crystallinity may be assessed by Differential Scanning Calerimetry (DSC).

The level of crystallinity in said first polymer may be at least 1%, suitably at least 3%, preferably at least 5% and more preferably at least 10%. In especially preferred embodiments, the crystallinity may be greater than 30%, more preferably greater than 40%, especially greater than 45%.

The main peak of the melting endotherm (Tm) for said first polymer (if crystalline) may be at least 300° C.

Said first polymer may consist essentially of one of units (a) to (f) defined above.

Said first polymer preferably comprises, more preferably consists essentially of, a repeat unit of formula (XX)

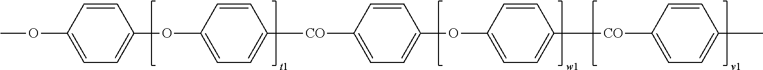

where t1, and w1 independently represent 0 or 1 and v1 represents 0, 1 or 2. Preferred polymeric materials have a said repeat unit wherein t1=1, v1=0 and w1=0; t1=0, v1=0 and w1=0; t1=0, w1=1, v1=2; or t1=0, v1=1 and w1=0. More preferred have t1=1, v1=0 and w1=0; or t1=0, v1=0 and w1=0. The most preferred has t1=1, v1=0 and w1=0.

In preferred embodiments, said first polymer is selected from polyetheretherketone, polyetherketone, polyetherketoneetherketoneketone and polyetherketoneketone. In a more preferred embodiment, said polymeric material is selected from polyetherketone and polyetheretherketone. In an especially preferred embodiment, said polymeric material is polyetheretherketone.

Especially preferred is the case wherein said film comprises and preferably consists essentially of a said preferred first polymer.

Said prepreg suitably includes thermoplastic or thermosetting resin and fibre reinforcement. Said prepreg suitably comprises 30 to 70vol % of resin and 70 to 30vol % of fibre reinforcement. Said prepreg preferably includes 40 to 60vol % resin and 60 to 40vol % fibre reinforcement.

More preferably, said prepreg includes 40 to 50 vol % resin and 60 to 50 vol % fibre reinforcement.

The melting point of each resin in the prepreg is preferably not more than the melting point of the film.

Said fibre reinforcement may be continuous or semi-continuous. Preferably, said fibre reinforcement is continuous.

Said fibre reinforcement may comprise a fabric or a uniaxial (unidirectional) tape. Said fibre reinforcement may be woven or knitted

Said fibre reinforcement may be selected from inorganic fibrous materials, non-melting and high melting organic fibrous materials. The fibre reinforcement may be selected from carbon fibre, glass fibre, aramid fibre, polyolefin (e.g. polyethylene) fibre, and boron fibres and fibres made from a said first polymer described above, for example polyetheretherketone fibre.

A said thermoplastic resin of a prepreg may be selected from a polyolefin (e.g. polyethylene), polyamide, polyaryletherketone, polyphenylene sulphide, polyetherimide, polyarylethersulphone, polyamideimide and liquid crystal polymers. Said thermoplastic resin may comprise a said first polymer as described above, for example polyetheretherketone.

A said thermosetting resin of a prepreg may be selected from an epoxy resin, polyester resin, vinyl ester resin, liquid crystal polymer, polyimide and bismaleamide resin.

The force to consolidate the prepreg may be applied in a manner which is conventional in prepreg consolidation or using any method described herein. Suitably, prepreg is urged by a force towards, preferably against, a part of a mould. The force suitably also acts to urge the prepreg and film towards one another so the film can become attached to the prepreg.

In a preferred embodiment, the film is arranged to apply the force to the prepreg to consolidate it. Preferably, the film is arranged to be urged by a fluid, for example gas, pressure towards the prepreg. In this regard, a said fluid may be arranged to act on one side of the film and the prepreg may be arranged to contact the other side of the film, the arrangement suitably being such that the fluid applies a pressure to the prepreg via the film to consolidate the prepreg. In one embodiment, said fluid may be provided by the atmosphere which may exert atmospheric pressure on the film. In this case, a vacuum may initially be formed between film and prepreg in which case the film may act as a bagging film. On formation of the vacuum, the film is urged under increasing pressure against the prepreg by the pressure exerted by the atmosphere. In another embodiment, the film may be pressurized by a fluid, for example gas, to above atmospheric pressure so that it is urged against the prepreg.

The method may be carried out at ambient temperature in some circumstances, but preferably includes causing the temperature of the prepreg to increase during its consolidation. Thus, the prepreg may be caused to be heated to melt resin of said prepreg. Heating may be effected using any conventional process, for example using an autoclave or oven or an induction heating technique. Preferably, heating is such that the film does not substantially melt until the prepreg has been substantially fully consolidated, suitably so the film can apply a pressure to the prepreg during substantially the entire consolidation process.

The temperature of the prepreg may in some cases be raised to in excess of 300° C., 325°, 350° or 375° during the consolidation process. The temperature of the prepreg is preferably not raised above 450° C., more preferably not above 410° C.

Preferably, at or towards the end of the consolidation process, a surface of the prepreg adjacent the film is at a sufficiently high temperature so that the film can become attached to the prepreg. In a preferred embodiment, the surface of the prepreg attains a temperature which is at or is in excess of the melting temperature of the film so that the film may be melted and therefore become attached to the prepreg.

Manufacture of prepreg and its laying up relative to a mould may use a conventional technique.

In a first embodiment of the method of the first aspect, a film is selected for use as a bagging film and is arranged adjacent a prepreg to be consolidated. The film is then caused to be urged against the prepreg to facilitate its consolidation, for example by evacuating a volume between the film and prepreg. At the same time, the prepreg may be heated. Thus, the prepreg is consolidated and at the end of the process the temperature of the film is arranged to be such that it melts and adheres and/or welds to the consolidated prepreg. Advantageously, the first embodiment may utilise a film of first polymer as described, especially a polyetheretherketone film. Preferably, also the prepreg comprises a said first polymer, for example polyetheretherketone, suitably as a matrix material.

In a second embodiment, a film may be arranged to define a gas receptacle which is arranged within an enclosed structure defined by prepreg. The prepreg in this case may comprise a woven structure for example produced in a knitting process. The prepreg may be arranged to define a hollow structure when consolidated. The hollow structure may be fully enclosed and may include substantially no openings providing access into the interior of the structure.

The method suitably includes filling the gas receptacle with a gas. The gas may be pressurised so that the gas receptacle is able to apply a force to the prepreg to consolidate it. For example, the prepreg may be urged by the gas receptacle against a mould within which the prepreg is laid up. The pressure of the gas may be increased by heating it. In the method, the gas receptacle and prepreg are suitably heated and the gas in the bag expands. The gas receptacle is suitably caused to expand. For example the resin from which it is made may yield. The expansion of the bag may force the prepreg against a mould in which it is arranged. At the end of the consolidation process, the arrangement may be such that the film of the receptacle melts and/or adheres and/or welds to the consolidated prepreg to leave a substantially continuous layer of film on the interior of the hollow structure formed. Advantageously, the second embodiment may utilise a gas receptacle defined by film of first polymer as described, especially a polyetheretherketone. Preferably, also, the prepreg comprises a said first polymer, for example polyetheretherketone, suitably as a matrix material.

In a third embodiment, a said film may be arranged on a mould or other fabrication tooling and prepreg may be laid up on the film. A bagging system may then be used as described herein to consolidate the prepreg. During the process, the film is caused to adhere or weld to the prepreg being consolidated. For example, the prepreg may comprise an epoxy resin and the film may comprise a first polymer, for example polyetheretherketone. During curing of the epoxy resin a bond may be formed between the epoxy resin and film such that the film forms a layer on the consolidated prepreg.

The consolidated prepreg described may define a composite material of a structure for use in aerospace, for example a wing box or exterior panel.

In a second aspect, the invention extends to a method of manufacturing a composite material which includes consolidating a prepreg as described according to the first aspect.

The method may comprise consolidating one or more layers of prepreg, suitably associated with a mould. In the method prepreg is suitably urged towards a surface of a mould, suitably so the prepreg adopts a shape defined by said surface.

In a third aspect, the invention extends to a method of protecting a surface of a consolidated prepreg, the method comprising:

(i) positioning a film adjacent a prepreg to be consolidated; and

(ii) applying a force for consolidating the prepreg, wherein the film becomes attached to the prepreg.

In a fourth aspect, the invention extends to a composite material which includes a consolidated prepreg as described herein and/or which is made in a method as described herein.

In a fifth aspect, the invention extends to a component which comprises a composite material as described. The component may be for a vehicle and/or for use in the aerospace or automotive industries; for use in marine applications; or for use in medical applications.

In a sixth aspect the invention extends to a consolidated prepreg formed in a method described for example in the first aspect.

In a seventh aspect, there is provided a consolidated prepreg which includes a layer of a film on a surface of the prepreg.

The prepreg and film may be as described in any statement herein. Preferably, the film comprises (preferably consists essentially of) a first polymer as described, especially polyetheretherketone. The presence of such a film will be apparent when a prepreg (or composite material or component) is sectioned, even if the prepreg itself contains the same resin as the film. Thus, the consolidated prepreg suitably includes a film layer on the prepreg which includes a lower concentration of fibre reinforcement compared to the level of fibre reinforcement present in a region of the prepreg adjacent the film layer. Preferably, the film layer includes substantially no fibre reinforcement, in a region thereof adjacent an exposed surface of the film layer.

In one embodiment, the prepreg includes a said first polymer, especially polyetheretherketone, associated with fibre reinforcement; and a film layer which also comprises a said first polymer, especially polyetheretherketone.

In another embodiment, there is provided a consolidated prepreg which includes a prepreg resin (e.g. a thermoset resin) having a degradation temperature of less than 300° C., 250° C. or 200° C., the consolidated prepreg including a layer of film, wherein the film includes a resin having a melting point which is at least 50° C. above the degradation temperature of the resin used. Thus, a film such as polyetheretherketone having a melting temperature of about 350° C. and which is melt processable at about 400° C., may be provided on a prepreg which comprises a prepreg resin with a relatively low degradation temperature, for example an epoxy or polyester resin. Thus, the consolidated prepreg described may include a consolidated prepreg which includes an epoxy or polyester (especially an epoxy) and a layer of a film of first polymer, especially of polyetheretherketone. The method described herein enables such materials to be made.

In another embodiment, the layer of film may be provided on an inwardly facing surface. For example, the consolidated prepreg may define a hollow structure and the layer of film may be provided on an internal surface of the hollow structure. The consolidated prepreg may comprise a resin which is suitably a thermoplastic resin as described herein for example of a said first polymer, for example polyetheretherketone. The layer of film may also include a thermoplastics resin as described herein for example of a said first polymer, for example polyetheretherketone.

According to an eighth aspect of the invention, there is provided a hollow structure which includes no openings providing access to an internal region of the hollow structure and includes no openings in the structure which have been filled or otherwise blocked and includes no joints between any two parts which define the hollow structure, wherein said structure comprises a layer of film and a layer comprising both a resin (which may be a thermoplastic resin, is preferably as described herein, is more preferably a said first polymer and is especially polyetheretherketone) and fibre reinforcement.

Thus, the hollow structure suitably includes no access openings and included no access openings at any time after it had been formed.

Preferably, the layer of film comprises a thermoplastic resin, more preferably comprises a said first polymer and, especially, comprises polyetheretherketone.

The layer of film preferably is provided on an internal surface of the hollow structure. The film suitably covers at least 60%, preferably at least 85%, more preferably at least 95%, especially at least 99% of the surface area of the internal surface of the hollow structure.

According to a ninth aspect, there is provided a method of making a hollow structure which includes a layer of film on an internal surface thereof, the method comprising:

selecting a hollow structure according to the eighth aspect; and

forming an opening in the hollow structure to provide a means of access from the outside to the inside of the structure.

The opening may be for receiving a fluid. The structure may be a fuel tank and the opening may be for passage of fuel. Advantageously, the method allows high performance films such as those of the first polymer to be used in protecting the inside of the hollow structure.

The invention extends to a hollow structure made as described according to the ninth aspect. Thus, the invention extends to a hollow structure which includes one or more openings providing access to an internal region of the hollow structure, wherein said structure comprises a layer of film on an internal surface thereof. The film may comprise a thermoplastic resin as described herein for example of said first polymer, for example polyetheretherketone. The film suitably covers at least 60%, preferably at least 85%, more preferably at least 95%, especially at least 98% of the surface area of the internal surface of the hollow structure. The film preferably covers substantially the entirety of said internal surface excluding any openings providing access to any internal region of the hollow structure.

Any feature of any aspect of any invention or embodiment described herein may be combined with any feature of any aspect of any other invention or embodiment described herein mutatis mutandis.

Specific embodiments of the invention will now be described, by way of example, with reference to the accompanying drawings, in which:

FIG. 1 is a cross-section of a known arrangement for consolidating a prepreg;

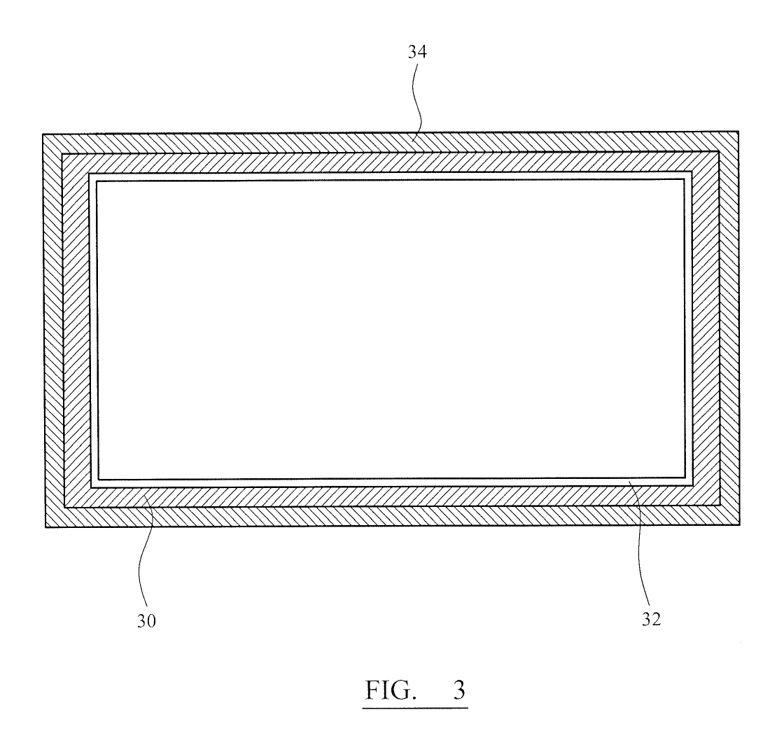

FIG. 2 is cross-section of an arrangement for consolidating a prepreg; and

FIG. 3 is a cross-section through a mould which includes a hollow knitted structure and gas filled bag.

In the figures, the same or similar parts are annotated with the same reference numerals.

The following materials are referred to hereinafter:

Victrex PEEK 90 (Trade Mark) grade resin—refers to polyetheretherketone resin having a melt viscosity of 0.09 kNsm⁻² and a melting point of 343° C. obtained from Victrex Plc, UK.

Victrex Aptiv PEEK (Trade Mark) film—refers to a polyetheretherketone film having a melting point of 343° C. and thickness of 25 μm obtained from Victrex Plc, UK. The film may be semi-crystalline or amorphous. In the examples, the Aptiv PEEK film used was semi-crystalline film grade 1000-025.

In general terms, a polyetheretherketone film is used in the consolidation of a prepreg so that the film becomes incorporated into the consolidated prepreg, defines an outer layer of the consolidated prepreg and therefore provides the consolidated prepreg with advantageous properties. Furthermore, the film can advantageously facilitate the consolidation process itself. Further details are provided below.

In a first embodiment, film may be used as a bagging material.

Prepreg was prepared comprising 280gm² 5-harness satin carbon fabric with 50% vol Victrex PEEK 90 grade resin. Prepreg was positioned in a mould to define a precursor of a composite material 20 as shown in FIG. 2. A Victrex Aptiv PEEK film was selected and used as a bagging film 22, with the film being positioned next to the prepreg, with no other material (e.g. no breather fabric 12 of FIG. 1) separating the bagging film from the prepreg.

A vacuum was applied via port 18 to evacuate the space between the prepreg and film 22 and induction heating used to cause the resin in the prepreg to melt. In addition the film 22 yields and draws and this stretched film will cover the prepreg and act as a bagging material.

Induction heating, which may use microwave or radio frequency waves, only works directly with conductive materials. In the embodiment described, the prepreg includes carbon fibre which is conductive and, accordingly, induction heating causes the carbon fibre to heat up. In turn, the heated carbon fibre conducts heat to the resin component of the prepreg and the resin then melts. Melting generally takes place from inside the prepreg outwardly. Since the film is not conductive, it is effectively transparent to the applied radiation. It is only melted once the entire prepreg has been melted and the outer surface of the prepreg adjacent the film can transfer sufficient heat to melt the film. It will be appreciated therefore that the film only tends to melt after the prepreg has been consolidated.

Thus, the prepreg becomes consolidated and, on consolidation, the bagging film melts and forms a part of the surface of the composite material defined by the consolidated prepreg. Thereafter, the consolidated prepreg is allowed to cool. Whilst the film is not reusable it provides a resin rich layer or region on the outside of the composite material which may have the following advantages:

(a) Providing a smoother more aerodynamic exterior surface.

(b) Providing a more damage resistant exterior surface. For example, the film may provide for better impact resistance and may reduce the risk of direct damage of a product defined by the composite material due to impact loads. Consequently, the integrity of the structure of the composite product may be enhanced.

(c) Providing a more chemically resistant exterior coating to the composite product. For example, a consolidated composite structure will often have some voidage (providing a route for ingress of chemicals) where consolidation has not been completed, especially in cases where low pressure consolidation techniques such as vacuum bagging techniques as described in FIG. 1 are used. The film may restrict access to such voidage in view of it providing a coherent continuous surface coating.

(d) Providing a surface with no exposed fibres and thus the fibre-matrix interface is protected from attack.

(e) Providing a means of tailoring properties of the surface. For example electrical properties may be adjusted. In this regard, if the surface consists of polyetheretherketone it will be insulating with the level of insulation depending on the thickness of the film formed. If an ESD polyetheretherketone compound is used in the manufacture of the film then controlled surface conduction can be achieved. Alternatively, the film may include bacterial agents, thereby to provide anti-bacterial properties for use in medical devices (or the like). The film may include anti-biofouling agents, for marine applications. It may include UV stabilisers, for example black components.

(f) Providing a surface which may be readily paintable. For example a polyetheretherketone surface can readily be painted with epoxy-based paint systems.

The use of induction heating as described may be relatively efficient compared to other methods as only the prepreg is heated directly and not the general environment. In addition, the method may minimise the time that external surfaces of the prepreg and/or film are at an elevated temperature and so may reduce the likelihood of any degration of polymer at the surface of the consolidated prepreg.

The procedure described in Example 1 may be adapted for use with prepreg comprising different resins and/or fabrics/fibres. For example, the procedure may be used with thermoplastic or thermosetting polymers. Examples of the former include polyethylene, polyamides, polyaryletherketones, polyphenylene sulphide, polyetherimide, polyarylethersulphones, polyamideimides and liquid crystal polymers. Examples of the latter include epoxy resins, polyester resins, vinyl ester resins, liquid crystal polymers, polyimide and bismaleamide resins. Such prepregs may include fibre presented in any form (e.g. woven, knitted, tapes etc). Examples of fibres include carbon fibres, glass fibres, aramid fibres, polyetheretherketone fibres, polyethylene fibres and boron fibres.

A wide range of different film types may be used and selected according to the nature of components in the prepreg. It is preferred that the film:

(i) Should have a melting point higher than or equal to the melting point of resin in the prepreg;

(ii) Should be compatible with resin in the prepreg;

(iii) Should not be an effective absorber of the applied radiation, when induction heating is used.

(iv) Has a Burst strength which is sufficient to prevent failure during application of the vacuum during the bagging operation. This would also be related to the thickness as the greater the film thickness, the more likely the film is to be sufficiently strong.

(v) Has good drapability so that it conforms to the contours of the composite lay-up. The lay-up would be defined as the primary stage in the manufacturing process where individual sheets/pieces of prepreg are cut and laid one on top of the other to form a ‘green’ unconsolidated component. This is the structure that would be bagged and consolidated.

(vi) Should have good puncture resistance to prevent puncture during preparation of the bagged composite lay-up.

The film may be in the form of a laminate or co-extrusion. For example, one layer of the laminate may be selected to have some desirable properties of a bagging film and one layer may have other desirable properties. For example, one layer of the film may be selected to be compatible with the resin in the prepreg so that the film can adhere to the prepreg as described. Another layer may be selected for its strength and/or its ability to maintain the integrity of the film during its use as a bagging material.

In situations wherein the film (or at least a layer thereof adjacent the prepreg) comprises a resin which is the same as (or is miscible with) a resin in the prepreg, the film may fuse to the prepreg.

When the film comprises a resin which is not miscible (or is only partially miscible) with resin in the prepreg, the film may adhere to the prepreg. In both cases, the film becomes a substantially permanent part of the composite product defined by the consolidated prepreg. When the film defines a discrete layer on the consolidated prepreg, the layer may have a peel strength in excess of 1 N/cm when assessed using a 90° C. peel following ASTM D3330.

The film may in some situations include other additives to modify its properties, as described above, and/or a surface formed from the film may be modified. In this regard surface modification may be used to improve bonding of the film to a prepreg or to a material (e.g. paint) which may subsequently be applied over the film. In some cases, it may be desirable to use a film which incorporates a metal layer as in a metallised film. The film may be for reducing overall gas permeability or to provide electromagnetic shielding.

A second embodiment addresses the problem of insertion and/or removal of an inflatable bladder in the manufacture of hollow articles as described in the introduction of this specification. The solution utilises a gas-filled thermoplastic bag, for example a bag made from Victrex Aptiv PEEK film filled with an inert gas, for example nitrogen, although the gas may be air, particularly if consolidation is not undertaken at high temperature.

Referring to FIG. 3, a hollow structure 30 is knitted using a resin impregnated continuous fibre and, during this, the gas filled bag 32 is inserted. After knitting has been completed, the bag is totally enclosed within the knitted structure. The structure is then placed inside a mould 24, the internal dimensions of which define the external dimensions of the product being manufactured. As the composite and bag system are heated, the gas in the bag expands and the pressure in the bag increases. As the pressure increases a point will be reached where the yield stress of the bag material is reached, at which point the bag will start to draw and its volume will increase. This increase in volume continues until the bag has forced the composite prepreg out against the walls of the mould so consolidating the prepreg. On cooling, the gas pressure is maintained at a reasonable level as the temperature of the structure and tooling decreases such that the composite structure is cooled under pressure to the point where it solidifies. The film of the gas filled bag leaves a continuous layer on the interior of the hollow structure.

As an alternative, the bag may be oversized for the knitted structure it is intended to fill and may be under-inflated in the method. Such an under-inflated bag can easily be inserted into the structure being knitted. As temperature is increased during the process, gas in the bag expands and brings about consolidation of the prepreg but in this case the film material does not yield. It does nonetheless leave a continuous layer on the interior structure of the hollow structure formed.

Thus, the processes described overcome any need to remove the bag. Furthermore, the internal film layer may act as a protective layer, for example where the hollow structure is to hold a fluid such as when it defines a fuel tank.

The first and second embodiments may be applied to prepregs which comprise thermoplastic or thermoset resins. A variation of the first embodiment which may be particularly advantageously applied to thermoset resins, for example epoxy resin based composite materials, involves using a film as described, for example a Victrex Aptiv film, on the surface of the mould or fabrication tooling. In the process, initially the film is drawn down against the mould/fabrication tooling; then the prepreg is laid up in a conventional manner in contact with the film; and then a suitable bagging material and bagging system is used. During curing of the epoxy resin, a bond will form between the thermoset resin and the film (e.g. between the epoxy of the prepreg and the polyetheretherketone of the Victrex Aptiv film) so that after consolidation the film remains adhered to the consolidated prepreg and may therefore provide many of the advantages (a) to (c) described above in the context of the first embodiment.

The process described may be applied to a wide range of composite structures for example wing boxes, wing structures, automotive vehicle bodies (main cabs and rear box cab sections), ambulance body shells operating tables and strechers. The latter two mentioned uses may easily be provided with sealed surfaces by providing a film on both sides using the methods described, to facilitate sterilisation.

In the aforesaid embodiments, film (e.g. Victrex APTIV film) may be selected which is crystalline or amorphous. The latter may be selected wherein the chemical resistance and other properties associated with crystalline materials is not required; the former may be selected where a chemically resistant layer is desired to be produced on the inside or outside of a consolidated prepreg.

Although in the embodiments described, the film is consumed in the processes and is therefore not useable, the processes are still commercially viable and may be cheaper in any event compared to prior art processes. For example, a polyetheretherketone film used as described according to the first embodiment may be significantly less costly than a silicone bag which may in some circumstances only be used once and do not provide any of the advantages described for the polyetheretherketone film, in the finished product.

The processes is described herein may allow improvements in efficiency of manufacture of composite materials in terms of energy and time; improve the ability to mass produce such materials; and improve the ease of scale of production, with lower capital costs.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A method of consolidating a prepreg, the method comprising:
(i) positioning a film adjacent a prepreg to be consolidated; and
(ii) applying a force for consolidating the prepreg, wherein the film becomes attached to the prepreg.

2. A method according to claim 1, wherein a consolidated prepreg is made in the method which includes an outer or inner surface defined at least in part by material of said film.

3. A method according to claim 1, wherein the film has a thickness in the range 5 μm to 750 μm; and the puncture resistance of the film is at least 10 kJ/m².

4. A method according to claim 1, wherein the film includes at least 95 wt % of a single resin.

5. A method according to claim 1, wherein said film comprises a material selected from a polyaryletherketone, a polyarylethersulphone, a polyphenylene sulphide, a polyetherimide, a polyamide, a polyolefin and a first polymer which has a moiety of formula 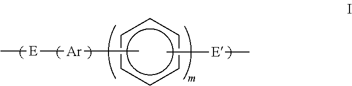
and/or a moiety of formula 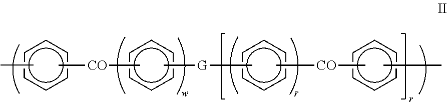
and/or a moiety of formula 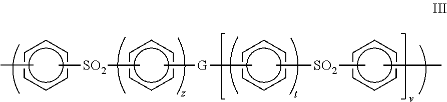
wherein m, r, s, t, v, w and z independently represent zero or a positive integer, E and E′ independently represent an oxygen or a sulphur atom or a direct link, G represents an oxygen or sulphur atom, a direct link or a —O-Ph-O— moiety where Ph represents a phenyl group and Ar is selected from one of the following moieties (i)**, (i) to (iv) which is bonded via one or more of its phenyl moieties to adjacent moieties

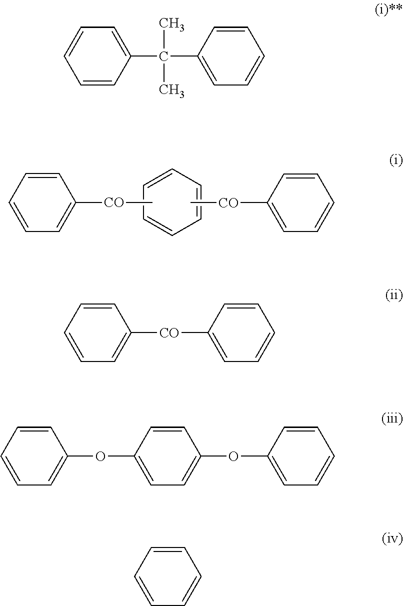

6. A method according to claim 1, wherein said film comprises a first polymer selected from polyetheretherketone, polyetherketone, polyetherketoneketoneetherketoneketone and polyetherketoneketone.

7. A method according to claim 1, wherein the melting point of the film is higher than or equal to the melting point of resin in the prepreg in a region of the prepreg to which the film becomes attached in the method.

8. A method according to claim 6, wherein said film consists essentially of said first polymer.

9. A method according to claim 1, wherein said prepreg includes thermoplastic or thermosetting resin and fibre reinforcement.

10. A method according to claim 9, wherein said thermoplastic resin of said prepreg is selected from a polyolefin, polyamide, polyaryletherketone, polyphenylene sulphide, polyetherimide, polyarylethersulphone, polyamide, liquid crystal polymer and a first polymer selected from polvetheretherketone, polyetherketone, polyetherketoneetherketoneketone and polyetherketoneketone.

11. A method according to claim 1, wherein the film is arranged to apply the force to the prepreg to consolidate it.

12. A method according to claim 1, wherein the temperature of the prepreg is raised to in excess of 300° C. during the consolidation process.

13. A method according to claim 6, wherein the film is selected for use as a bagging film and is arranged adjacent a prepreg to be consolidated; and is then caused to be urged against the prepreg to facilitate its consolidation.

14. A method according to claim 1, wherein said film is arranged to define a gas receptacle which is arranged within an enclosed structure defined by prepreg.

15. A method according to claim 1, wherein the prepreg is arranged to define a hollow structure when consolidated.

16. A method according to claim 1, wherein a said film is arranged on a mould or other fabrication tooling and prepreg is laid up on the film.

17. A method of manufacturing a composite material which includes consolidating a prepreg as described in claim 1.

18. (canceled)

19. A component which comprises a composite material described in claim 17.

20. A consolidated prepreg which includes a layer of film on a surface of the prepreg.

21. A prepreg according to claim 20, wherein the film comprises polyetheretherketone.

22. A prepreg according to claim 20, wherein the prepreg includes plyetheretherketone associated with fibre reinforcement; and a film layer which also comprises polyetheretherketone.

23. A prepreg according to claim 20, which include a prepreg resin having a degradation temperature of less than 300° C., the consolidated prepreg including a layer of film, wherein the film includes a resin having a melting point which is at least 50° C. above the degradation temperature of the resin used.

24. A prepreg according to claim 20, wherein the layer of film is provided on an inwardly facing surface.

25. A prepreg according to claim 20, wherein the consolidated prepreg comprises a thermoplastic resin.

26. (canceled)

27. (canceled)

28. (canceled)

29. A method according to claim 1, the method comprising:
(i) positioning a film having a thickness of less than 500 μm adjacent a prepreg to be consolidated; and
(ii) applying a force for consolidating the prepreg wherein said force is applied by said film and wherein the film becomes attached to the prepreg; and
wherein the method includes raising the temperature of the prepreg to in excess of 300° C. during the consolidation process.
